(19) United States
(12) Patent Application Publication
(10) Pub. No.: US 2014/0325404 A1
(43) Pub. Date: Oct. 30, 2014

(54) Generating Screen Data

(71) Applicant: Microsoft Corporation, Redmond, WA (US)

(72) Inventors: Denis Gennadyevich Khromov, Achinsk (RU); Sergey Aleksandrovich Kozhukhov, Moscow (RU); Yaroslav Olegovich Boyarinov, Moscow (RU)

(21) Appl. No.: 14/264,743

(22) Filed: Apr. 29, 2014

(30) Foreign Application Priority Data
Apr. 30, 2013 (RU) PCT/RU2013/000377

(51) Int. Cl. G06F 3/0484; G06T 13/80

(52) U.S. Cl. CPC G06F 3/04845; G06F 3/0484; G06T 13/80
USPC 715/763

(57) ABSTRACT

Disclosed herein is a computer implemented method for generating transition data for displaying on a screen at least one transition image between a source image and a destination image. The method comprising accessing a source set of element identifiers. The element identifiers define static elements in a source image and display data for each element. The method further comprises accessing a destination set of elements identifiers defining static elements in a destination image and display data for each element, identifying at least one matching static element in the source and destination set; and generating transition data based on the display data for the matching static element in the source set and the destination set.

This application claims priority under 35 USC §119(b) to International Application No. PCT/RU2013/000377 filed Apr. 30, 2013, the disclosure of which is incorporate in its entirety.

### BACKGROUND

Computer devices such as smartphones, tablets, laptops, personal computers etc. have user interfaces (UIs) incorporating a display screen, which displays control elements and application data to a user. users can move these display elements around by “dragging” or “swiping” using a touch sensitive screen or mouse.

A developer may wish to build a UI which involves a transition from one (source) screen image to another (destination). The source and destination images may comprise one or more respective elements, some (but not necessarily all) of which may be common to both screens.

There may be circumstances in which it is desirable for the source image to dynamically transition to the destination image. That is, for the various elements to be “animated” during the transition. For instance, if a first element appears in both the source and destination screen images at different respective locations, it may be desirable for the element to appear to move from an initial position in the source screen image to a final position in the destination screen image during the transition. Similarly, if a second element appears in only the source (resp. destination) screen image, it may be desirable for it to appear to move to (resp. from) a location outside of the screen image i.e. “out of view” (resp. “into view”) during the transition.

However, in known UI frameworks, a developer is required to manually describe such animations. For instance, in order to achieve an effect as described above, a developer would be required to somehow specify that ‘an element A moves from a position X in the source to position Y in the destination in time t’ etc.

### SUMMARY

Disclosed herein is a computer implemented method for generating transition data for displaying on a screen at least one transition image between a source image and a destination image. The method comprising accessing a source set of element identifiers. The element identifiers define static elements in a source image and display data for each element. The method further comprises accessing a destination set of elements identifiers defining static elements in a destination image and display data for each element, identifying at least one matching static element in the source and destination set; and generating transition data based on the display data for the matching static element in the source set and the destination set.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

For a better understanding of the present invention and to show how it may be put into effect, reference is made by way of example to the accompanying drawings in which:

FIG. 1 is a schematic representation of a mapping method with accompanying schematic representation of screen images,

FIG. 2 is a schematic representation of an apparatus, and

FIG. 3 is a schematic representation of a manner in which transition data may be generated.

FIG. 4 illustrates a first exemplary transition generated by a framework.

FIG. 5 illustrates a second exemplary transition generated by a framework.

FIG. 6 illustrates a third exemplary transition generated by a framework.

### DETAILED DESCRIPTION

Software frameworks may be used to aid software development by providing software having generic functionality. The framework may be “wrapped-up” by a suitable application programming interface. In order to create application-specific software, a developer can modify a framework by selectively adding their own code to the generic framework. This can reduce development time, and allow developers to focus on the bespoke aspects of application-specific, end-user software as opposed to the more standard low-level details. A distinguishing feature of frameworks is that the overall program control flow is dictated by the framework (in contrast to software libraries etc.).

One form of software framework is a User Interface (UI) framework, which facilitates the development of UIs.

Disclosed herein is a novel framework which is able to automatically generate transitions. That is, a framework which is able to process static layouts defined by a developer and which is able to automatically map the transition of elements from one screen image to another.

Either or both of a source screen image and a destination screen image may comprise one or more elements. If both the source screen image and the destination screen image comprise elements, those elements may be matching or different. Some elements may be comprised in one screen image but not the other. The elements may represent application controls, data, pictures, icons, videos, animations etc. The elements may be for user input. The elements may be moveable by a user between different locations in the screen images or be capable of being added or removed from a screen image by a user. The elements may be moveable indirectly by the user, i.e. elements may move between one screen image and another, or appear to disappear between one screen image and another as a direct or indirect consequence of user action. The elements may be moveable by the apparatus that generates the screen images completely independently of any user input. The screen images may be intended for display as part of a graphical user interface (GUI), the GUI being underpinned by the framework.

In the following embodiments, layout controllers provide a set of static descriptions of UI elements that represent application controls/data. The set then can be directly rendered to a screen of a device or can be merged with another set of static descriptions, and so on. On any procession stage the set can be stored and used later when a new layout will be generated according to newly arrived data, screen or device orientation change, or user defined layout changes. A merge set of descriptors can be used to render a transition screen when a UI transitions from a source screen to a display screen. A merge can be smooth, from source layout to destination layout, moreover at any particular stage of transition, it can be stored and then used as a source or destination layout for another transition. The above provides a framework for a developer who is released from the need to generate an animation for each time a screen transitions for any of the above reasons.

This greatly facilitates the generation of screen data for screen transitions, which can then be incorporated into bespoke code for a particular device/set of display elements.

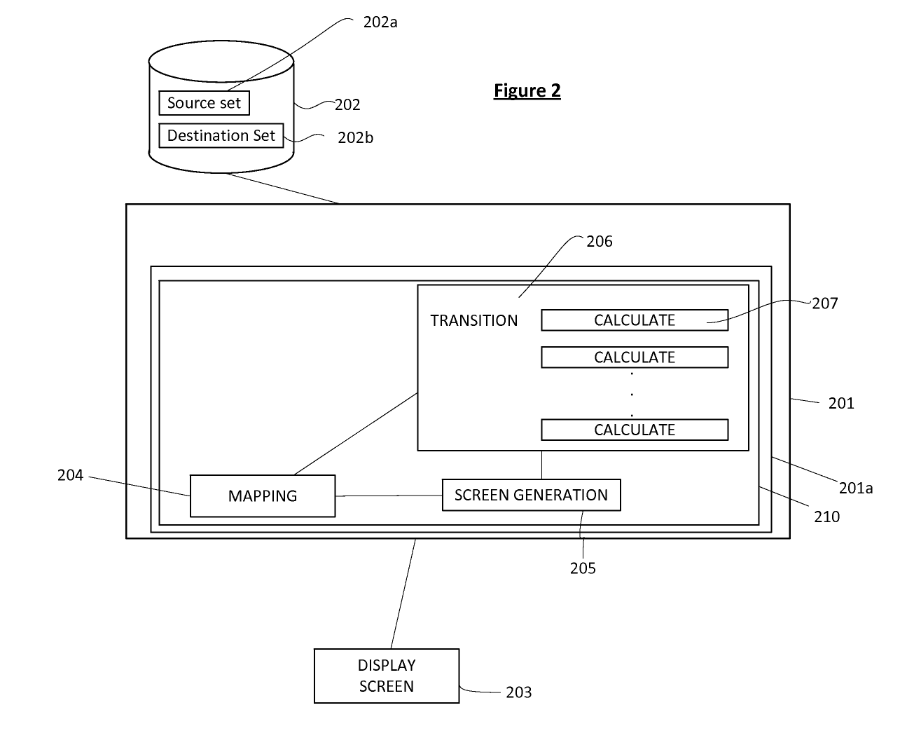

A CoordCalculator (207, FIG. 2) generates a set of static elements, identified by RenderItems, that represent application controls and data. Multiple independent calculators can be used at the same time. Each element is identified by a RenderItem which contains a reference to a data element containing text, images and other data, a type of RenderItem (IMAGE, TEXT and so on), and layout related information: occupied rectangle, z-order, color, opacity and so on. A CellRenderer in a screen generation module (205, FIG. 2) can render this set to the screen.

A merge (blend) between two sets can be performed in different ways depending on any criteria to generate a merge set—transition data for rendering a transition image—between a source image and a display image. A “merge” is parameterized by a ratio (from 0 to 1.0) between “amount” of layout to take from the source set and 1.0—“amount” to take from the destination set. A linear merge can be made according to rules such as:
Numbers (coordinates, colours, opacity, rotation, z-order) are merged by linear interpolation.
Images and texts are merged by alpha-transition.
The proportion of the interpolation of each set is governed by the parameterization.

For example, a 50% merge would linearly interpolate half way between the numerical values for each of the above numbers. The parameters can also include the number of transitions (merge sets) required between each source and destination screen.

All layouts are generated by static CoordCalculators that are aware only about a bounding box rectangle: all the transitions are generated by linear interpolation between two sets of layouts. This has the advantage that a developer need only define the static elements—the framework tool described herein automatically generates the merge (transition) data in a user device.

In order to generate transition data, an element in a source screen image needs to be matched with (mapped to) the same element in a destination image. This is done using the RenderItem reference to the element.

Data is then generated representing the transition, which may then be used to generate one or more intervening screen images. Each merge set can render a screen image. The intervening screen images may be displayed between the source screen image and the destination screen image. The intervening screen images show the one or more elements transitioning from their arrangement in the source screen image to their arrangement in the destination screen image. This transitioning may be shown in an incremental fashion, so that each successive screen images looks progressively more similar to the destination screen image than the preceding screen image.

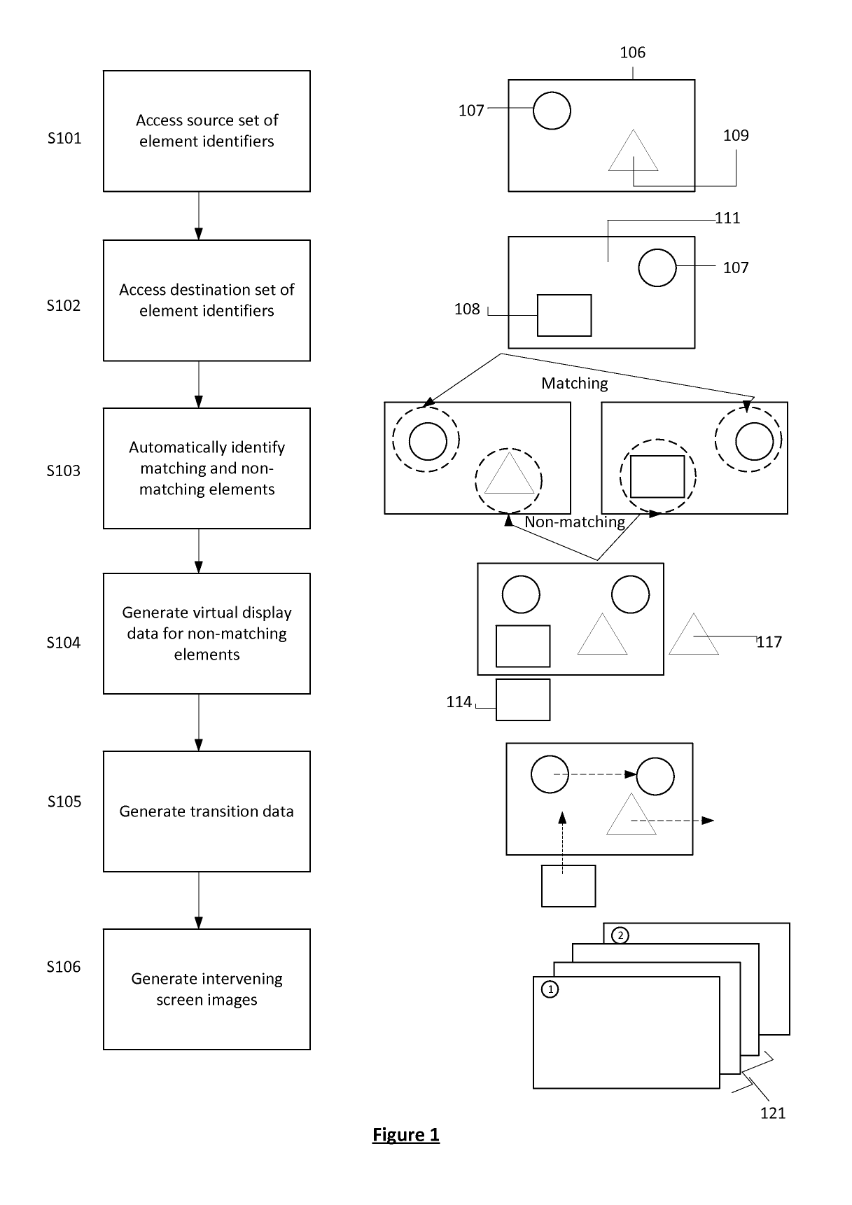

FIG. 1 shows a schematic block diagram of an illustrative method for generating transition data on the left-hand. The transition data is used to display at least one transition image between a source image 106 and a destination image 111. A pictorial representation of the method is shown on the right-hand side. The method may be performed in response to a change to the screen image being initiated. This change may be initiated by a user or an apparatus (which could be, for example, an end-user computing device or a server).

The method starts by accessing a source set of element identifiers (S101). The source set defines static elements 107, 109 in a source image 106, as well as display data for each element (e.g. coordinates, colours, opacity, rotation, z-order etc.). On the right-hand side, source screen image 106 is shown comprising two elements, represented by circle 107 and triangle 109.

At step S102, a destination set of element identifiers is accessed. The destination set defines static elements 108, 107 in a destination image 111, as well as display data for each element (e.g. coordinates, colours, opacity, rotation, z-order etc.). On the right-hand side, the destination screen image 111 is shown comprising two elements, circle 107 and rectangle 108

In effect, during the transition, the source screen image is to be changed by moving circle 107 to the right, removing triangle 109 and introducing a new element, square 108.

The next step is to automatically identify matching and non-matching elements in the two screen images (step S103), based on the element identifiers in the source and destination sets.

In some instances, only matching elements may be identified (e.g. if there are no non-matching elements). Equally, in other instances, only non-matching elements may be identified (e.g. if there are no matching elements).

In step S104 virtual display data is generated for any non-matching elements, such as elements 108 and 109. The virtual display data corresponds to an arrangement of the non-matching element in either the source image or the destination image that is non-visible (e.g. an off screen arrangement, a zero-opacity arrangement etc.). This means that, during the transition, non-matching elements gradually become visible/non-visible (e.g. by moving into/out of view or by fading in/out).

For a first non-matching element that is defined only in the source set (109), a virtual element identifier (117) defining the first non-matching element (and defining virtual display data corresponding to a non-visible location in the destination image) is generated in the destination set. For a second non-matching element that is defined only in the destination set (108), a virtual element identifier (114) is generated in the source set defining the second non-matching destination element in the source set (and defining virtual display data corresponding to a non-visible arrangement in the source image).

More specifically, the circle is associated with an arrangement in the source screen image and an arrangement in the destination screen image as defined by respective display data within the source and destination sets. However, the square does not appear in the source screen image so virtual display data is generated in the source set defining an off-screen arrangement. This off-screen arrangement could be associated with both x and y-coordinates (with the y-coordinates being negative) or just with x-coordinates (the y-coordinates could, for example, be set to zero). The square's screen arrangement in the destination screen image is shown at 115 as defined by the destination set. Similarly the triangle has an on-screen arrangement 116 in the source screen image (defined by the source set) and an off-screen arrangement in the destination screen image, defined by virtual display data generated at S104. Elements that appear or disappear between the source screen image and the destination screen image may be represented by any suitable off-screen arrangement, and the arrangements shown in FIG. 1 are merely examples. Equally, elements that appear or disappear between the source screen image and the destination screen image need not be associated with an off-screen arrangement at all. For example, elements might “fade-in” or “fade-out” between the two screen images, in which case they may be associated with the same location in both screen images (i.e. on-screen) but have different opacities (and therefore different screen arrangements) in the source screen image and the destination screen image).

Step S104 is optional and does not need to be performed if there are no non-matching elements.

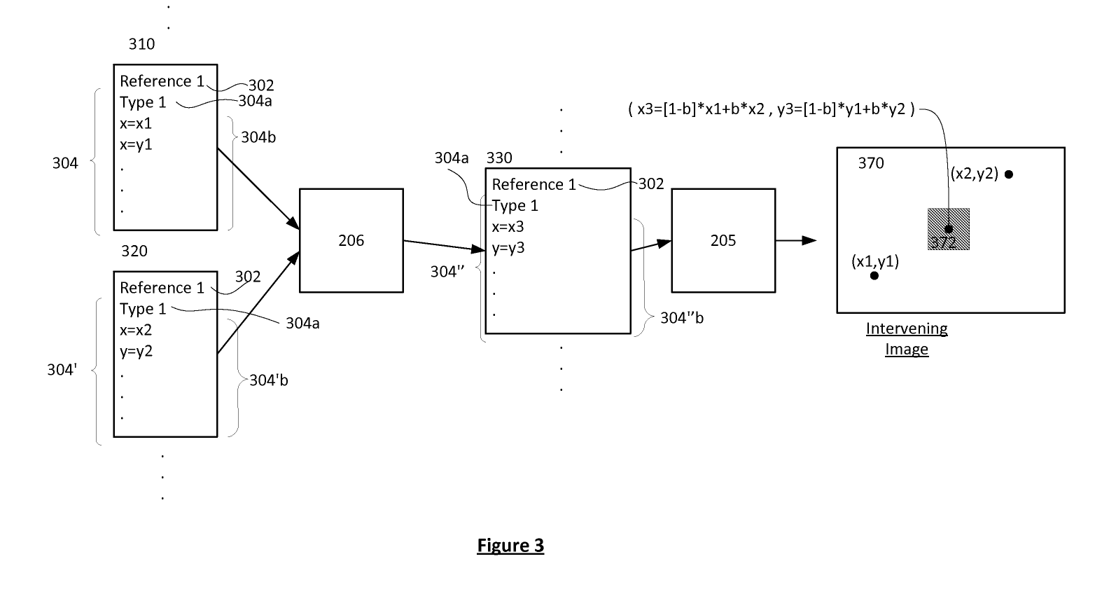

In step S105, transition data is generated by linearly interpolating between the source set and the destination set to create a plurality of merge sets parameterized by different parameters b running from 0.0 to 1.0. The merge sets are rendered sequentially in increasing order of b. This generation is described in more detail below with reference to FIG. 3.

The screen arrangements determined in step S104 may be set by the apparatus generating the transition data in order to achieve a particular visual effect. Examples of such visual effects include swipe and alpha transition. There is likely to be greater scope for doing this when elements are not present in one of the source screen image or the destination screen image because their screen arrangement in one of the screen images is then largely a matter of choice for the apparatus. The apparatus may make different choices for different elements. The apparatus may be configured to select particular visual effects for particular types of element. For example, videos may move from left-to-right while photos may move from right-to-left.

In step 106 one or more intervening screen images are generated. On the right-hand side, two intervening screen images are shown at 121. Suitably the effect of the intervening screen images is to show the elements incrementally transitioning from their arrangement in the source screen image to their arrangement in the destination screen image.

In embodiments, the display data may be linearly interpolated between the source set and the destination set to generate at least one transition image.

In embodiments, the transmission data may generated by alpha transition for elements which are image or text.

The novel framework can allow a developer to specify a desired number of transition images between the source image and destination image, which can be accessed when determining how to generate the intervening screen images.

The transition data may be of the form of one or more intervening sets of element identifiers defining static elements in a respective intervening image and display data for each element. At least one of the intervening sets may be stored in memory and subsequently used as a further source set and/or further destination set on which a further transition is based.

The method may be implemented by a computer program 210 having a framework code base derived from the framework, the framework code base operable to generate (and render) transition data as part of generating a user interface. That is, the computer program product may be built (e.g. by a software developer) around the novel framework.

The framework code base may be operable to generate transitions automatically in real-time, based on static layout information.

An example of an apparatus (user terminal) that may automatically generate transition data between screen images is shown in FIG. 2. The apparatus is shown generally at 201. The apparatus comprises a processing apparatus 210a in the form of a processor or CPU having one or more execution units on which computer program 210 is executed. The apparatus either comprises or is communicatively coupled to a computer-readable storage medium (memory) 202 such as a flash memory or other electronic memory, a magnetic storage device, and/or an optical storage device. Memory 202 stores at least one source set of element identifiers (202a) defining static elements in a source image, and at least one destination set of element identifiers (202b) defining static elements in a destination image. The apparatus also either comprises or is communicatively coupled to a display screen 203. If the apparatus is connected to an external memory or external display screen, that connection may be via either wired or wireless means.

When executed, the computer program 210 implements a screen generation module (CellRenderer) 205, a mapping module 204 and a transition module 206. The transition module comprises a plurality of calculation modules (CoordCalculators) 207, which are suitably arranged in a parallel configuration so as to be capable of simultaneously calculating transition data for multiple different elements. The screen generation module, mapping module and transition module are communicatively coupled to each other.

The screen generation module may be configured to generate screen images from sets of element identifiers. Those screen images may be for a GUI. The apparatus may comprise the GUI itself For example, the apparatus may be, or may be incorporated within, an end-user computing device with a GUI such as a personal computer, laptop, tablet, mobile phone or smart phone. The apparatus might also be configured to generate screen images for another, physically separate device, in which case it may or may not have its own GUI. For example, the apparatus may be, or may be incorporated within, a server configured to transmit the screen images to a third party device.

The screen generation module may generate the source screen image and the destination screen image. Either of these may be generated dependent on user input, input from user applications or other software, data stored in memory etc. The screen image generator also suitably generates the intervening screen images. This may be done in dependence on transition data received from the transition module.

The mapping module is configured to identify matching/non-matching elements in the source and destination sets.

Each of these modules or stages may be implemented as a portion of code stored on the transmitting terminal's storage medium 14 and arranged for execution on its processing apparatus 16, though the possibility of some or all of these being wholly or partially implemented in dedicated hardware circuitry is not excluded.

FIG. 3 illustrates how transition data is generated. FIG. 3 shows an element identifier (RenderItem) 310 which forms part of a source set defining static elements in a source image, and element identifier 320 which forms part of a destination set defining a set of static elements in a destination image. Identifier 310 defines an element which matches the element of identifier 320. One of identifiers 310, 320 may be a virtual element identifier generated in S104 (if the element is only visible in one of the source and destination images).

Identifiers 310 and 320 each include a reference 302 to a same data element, which may comprise images, text, or other data to be displayed on the screen. Data elements may be stored in memory at a suitably addressed location.

The source identifier includes display data 304, the display data including type data 304a. The type data 304 identifies the type of the data element. The type may be (e.g.) “IMAGE”, “TEXT” etc. The display data 304 also includes layout information 304b defining x and y coordinates (x1, y1). In addition, display data may also define at least one of: colours, opacity, rotation, and z-order.

The destination identifier 320 includes display data 304′, the display data including type data 304a which matches the source identifier 310. The display data 304′ also includes layout information 304′b defining x and y coordinates (x2, y2). In addition, display data may also define additional information such as, colours, opacity, rotation, and z-order.

After the matching/non-matching elements have been identified, the source and destination sets which include identifiers 310 and 320 respectively are input to transition module 206. Transition module 206 generates a merge set of element identifiers defining static elements in an intervening image of the transition and display data for each element. The merge set includes a merge element identifier 330 corresponding to the same element as identifiers 310 and 320, and which is generated by one of the plurality of calculation modules.

Merge identifiers 330 includes layout data 304″b which is a linear interpolation of layout data 304b and layout data 304′b, parameterized by parameter b, with 0.0<b<1.0. For instance, as shown in FIG. 3, display data 304″b define an x coordinate x3=(1−b)*x1+b*x2 and a y coordinate y3=(1−b)*y1+b*y2.

The merge set (including merge identifier 330) is then output to screen generation module 205, which renders the merge set as an intervening image 370 on the screen 203. Merge identifier 330 is rendered as element 372.

Additional transition data (not shown) are also generated in the form of additional merge sets (not shown) parameterised by a parameter b′ having a value different to b (and therefore having different layout information), which correspond to intervening images at other stages of the transition and which are rendered to the screen at different times. That is, multiple merge sets are generated with parameters increasing from 0.0 to 1.0 and are sequentially rendered to the screen during the transition.

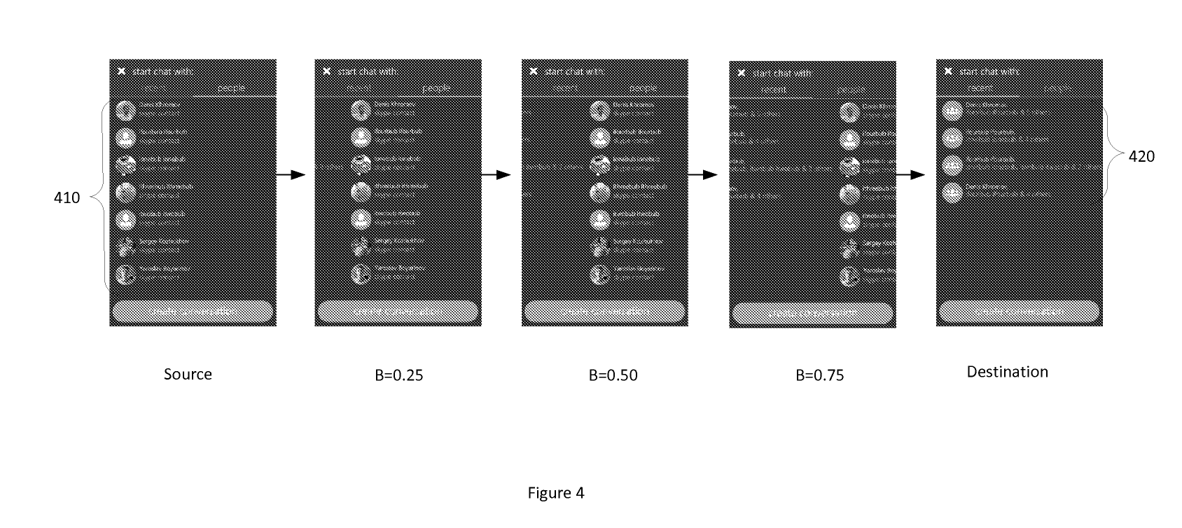

Examples of transitions generated by the framework are shown in FIGS. 4 to 6. The layouts are generated by static CoordCalculators that are aware only about a bounding box rectangle: all the transitions are generated by linear interpolation between two sets of layouts—a source set and a destination set. The proportion of the interpolation of each intervening set is governed by a parameter B which runs from 0.0 to 1.0.

FIG. 4 shows source and destination images in which there are non-matching elements 410, 420. In this instance, the framework automatically generate virtual display data for non-matching elements 410 corresponding to a non-visible arrangement (in this case, an off-screen location) in the destination image. The framework also automatically generates virtual display data for non-matching elements 420 corresponding to a non-visible arrangement (in this case, an off-screen location) in the source image.

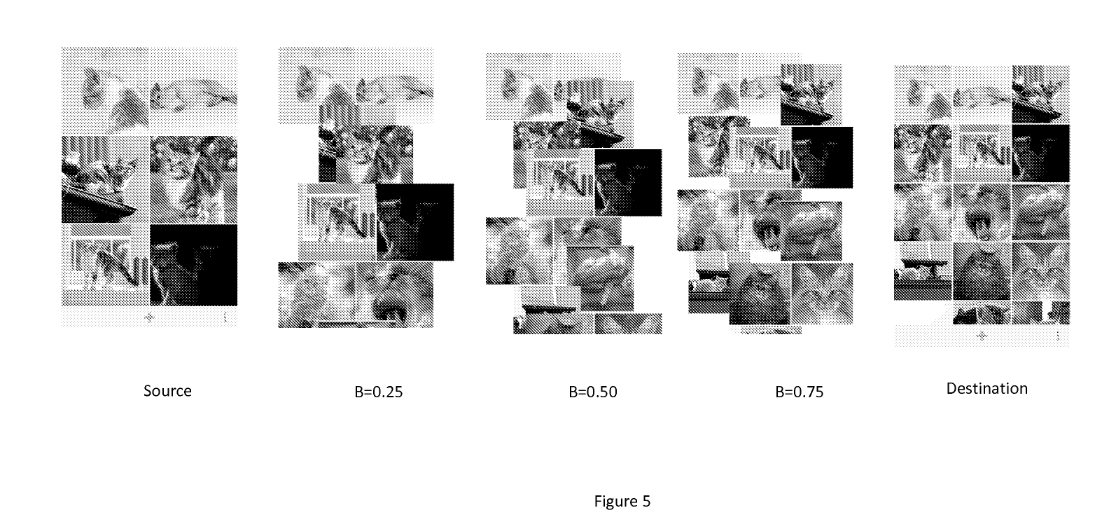

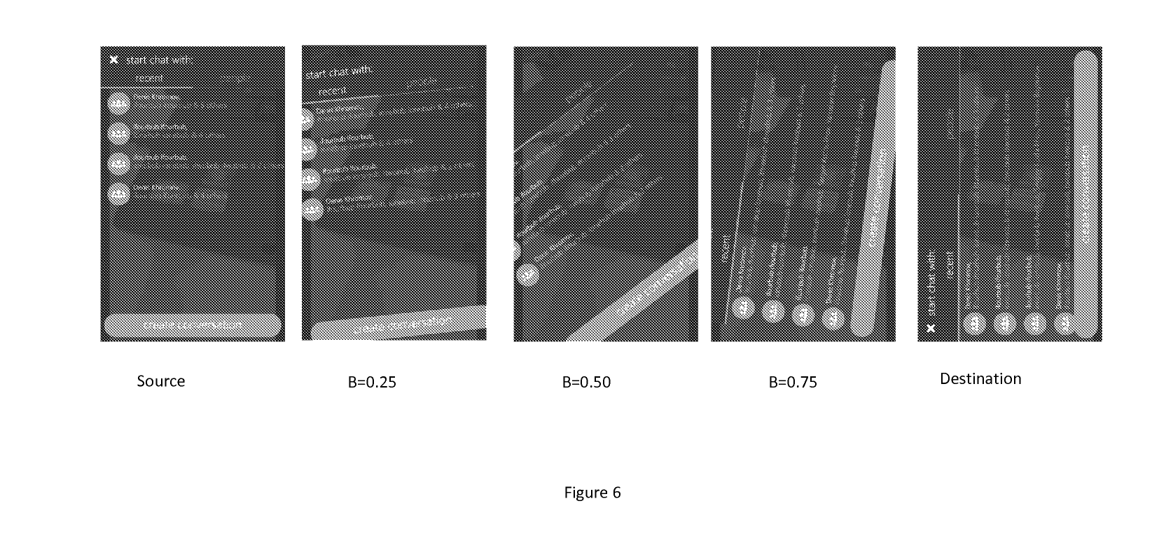

FIG. 5 shows a combination of matching and non-matching elements, in which off-screen virtual display data is generated automatically for non-matching elements FIG. 6 illustrates specifically a device orientation change transition.

The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method for generating transition data for displaying on a screen at least one transition image between a source image and a destination image, the method comprising:
accessing a source set of element identifiers defining static elements in a source image and display data for each element;
accessing a destination set of elements identifiers defining static elements in a destination image and display data for each element;
identifying at least one matching static element in the source and destination set; and
generating transition data based on the display data for the matching static element in the source set and the destination set.

2. The method of claim 1, wherein the display data is linearly interpolated between the source set and the destination set to generate at least one set of transition data.

3. The method of claim 2, wherein the display data is numerical and defines at least one of: coordinates, colours, opacity, rotation, and z-order.

4. The method of claim 1 comprising rendering a transition image on the screen from the transition data.

5. The method of claim 4, comprising accessing a desired number of transition images between the source image and destination image.

6. The method of claim 1, wherein transition data is generated by alpha transition for elements which are image or text.

7. The method of claim 1, wherein the display data includes the type of element.

8. The method of claim 1, wherein the display data includes layout related information.

9. The method of claim 1, wherein the transition data is of the form of one or more merge sets of element identifiers defining static elements in a respective intervening image and display data for each element.

10. The method of claim 8, wherein at least one of the intervening sets is stored in memory and the method further comprises generating a further transition using the at least one intervening set as a further source set and/or further destination set.

11. The method of claim 1, comprising rendering a succession of intervening screen images on the screen based on the transition data, wherein the transition data is generated such that each successive screen image is progressively closer in appearance to the destination screen image than the preceding screen image.

12. The method of claim 1, wherein the transition data represents movement of one or more elements from their position in the source screen image to their position in the destination screen image.

13. The method of claim 1 further comprising: for an element that is defined in only one of the source set or the destination set, generating transition data that represents the movement of those one or more images between a respective off-screen position and a respective on-screen position.

14. The method of claim 1 further comprising, for an element that is defined in only one of the source set or the destination set, generating transition data that represents a respective fading-in or fading-out of those elements between the source screen image and the destination screen image.

15. The method of claim 1, wherein transition data is generated independently for each of the one or more elements.

16. A computer implemented method for generating transition data for displaying on a screen at least one transition image between a source image and a destination image, the method comprising:
accessing a source set of element identifiers defining static elements in a source image and display data for each element;
accessing a destination set of elements identifiers defining static elements in a destination image and display data for each element;
identifying at least one matching static element in the source and destination set; and/or
identifying at least one non-matching static element in one of the source set and destination set and generating virtual display data corresponding to a non-visible arrangement of the non-matching element in one of the destination image and source image respectively; and
generating transition data based on the display data for the matching static element in the source set and the destination set and/or based on the display data and virtual display data for the non-matching static element.

17. A software framework product for generating transition data, the framework comprising code which when executed is operable to perform operations according to the method of claim 1.

18. A computer program product for generating a user interface and having a framework code base derived from the framework of claim 17, wherein the framework code base is operable to generate transition data as part of generating the user interface.

19. A user device comprising:
a screen;
a memory holding a source set of element identifiers defining static elements in a source image and display data for each element and a destination set of elements identifiers defining static elements in a destination image and display data for each element;
a processor configured to execute a computer program which accesses the source and destination sets, identifies at least one matching static element in the source and destination set, generates at least one set of transition data based on the display data for the matching static element in the source set and the destination set, and renders the transition data as an intervening image on the screen,
wherein the display data is linearly interpolated between the source set and the destination set to generate the at least one set of transition data according to an interpolation factor, and wherein each set of transition data defines static elements for display.

20. The apparatus of claim 18, wherein the display data includes layout related information.
